(19) United States
(12) Patent Application Publication
(10) Pub. No.: US 2008/0113657 A1
(43) Pub. Date: May 15, 2008

(54) Method of non-intrusive control of mobile device

(76) Inventors: Marwan Hassan Abu-Amara, Dhahran (SA); Ashraf S. Hasan Mahmoud, Dhahran (SA)

Correspondence Address: LITMAN LAW OFFICES, LTD., P.O. BOX 15035, CRYSTAL CITY STATION, ARLINGTON, VA, 22215, US

(21) Appl. No.: 11/599,457

(22) Filed: Nov. 15, 2006

(51) Int. Cl. H04M 3/42; H04Q 7/38

(52) U.S. Cl. 455/415; 455/456.1

(57) ABSTRACT

The method of non-intrusive control of mobile device provides for remote control of ringer sound level and auditory volume of a mobile device, dependent upon the location of the device. A set of location-dependent rules are established and stored in a database. The location of the mobile device is determined and compared to the location-dependent rules in the database. A control signal is transmitted by the wireless mobile network to the mobile device to adjust the ringer sound level and/or auditory volume of the device. Alternatively, the mobile device may be programmed with a user-consent routine, requiring the user to provide consent before the control signal may adjust the volume. If the ringer sound level is set to zero, the user's subsequent messages may be automatically rerouted to a voicemail system.

### BACKGROUND OF THE INVENTION

1. Field of the Invention

The present invention relates to systems for wireless communication, such as cellular phone systems, and particularly to a method for non-intrusive control of a mobile device that provides for controlling the volume and the ringer signal of a mobile or portable phone or similar device dependent upon the geographic location of the mobile device.

2. Description of the Related Art

Mobile devices, such as cellular telephones, pagers, personal digital assistants, handheld computers and the like often generate audio signals that can be disturbing to others in the immediate vicinity. Telephone ringers, audio paging signals, speakerphone audio transmissions and other audio signals generated by the mobile devices are often set to a volume that interferes with the activities of other people in the area surrounding the user of the mobile device. In certain environments, such as places of worship, schools, hospitals, stage theaters, movie theaters, and like, it may be required, as a matter of courtesy or of necessity, to turn off audio transmissions produced by mobile or portable devices.

Some environments, such as military installations and hospitals, embed walls and other structural elements with electromagnetic shielding, effectively severing contact between the mobile device and the associated mobile wireless network. Although effective at eliminating unwanted audio signals from the mobile devices, this extreme measure also terminates all wireless functionality associated with the device. In an emergency situation, for example, the wireless device may not be used to transmit an emergency signal to the external environment.

Similarly, jamming or interference signals have been utilized to disable mobile devices, with similar results to those described above. Although a non-jamming signal may be used to remotely and automatically lower the volume of a mobile device, or to turn off the audio system completely, such a system does not allow for variation in particular circumstances. For example, the volume of a telephone ringer may only need to be lowered to a level that will not interfere with others in the environment, but a signal may be sent to completely shut down the telephone audio system, thus inconveniencing the user when it is not at all necessary.

Further, in most circumstances, it will not be necessary to provide others with control over the telephone, i.e., except when absolutely necessary, users will want to maintain control over whether they allow the volume to be remotely adjusted or not.

Thus, a method of non-intrusive control of a mobile device solving the aforementioned problems is desired.

### SUMMARY OF THE INVENTION

The method of non-intrusive control of a mobile device provides for the remote control of an auditory volume and ringer sound level associated with a mobile device, dependent upon the location of the device. As used herein, the term “mobile device” refers to a mobile phone, a handheld terminal, or a portable device. A set of location-dependent volume and ringer sound level rules are established and stored in a database. A subset of control rules and routines is associated with each particular location stored in the database. The location of the mobile device is determined and compared to the location-dependent volume rules in the database. The location of the mobile device may be determined through the local wireless access point in the case of a Bluetooth enabled mobile device, through the use of the global positioning system (GPS) for GPS-enabled devices, or through other suitable methods for devices that are not GPS enabled.

A control signal is transmitted by the wireless mobile network to the mobile device to adjust the auditory volume and ringer sound level of the device, dependent upon the subset of volume rules for the particular location. Alternatively, the mobile device may be programmed with a user-consent routine, requiring the user to provide consent before the control signal may adjust the volume. Further, if the volume is set to zero, the user's subsequent messages may be automatically rerouted to a voicemail system, or other sensory alarms may be actuated, such as tactile alarms or visual alarms.

Further, rather than providing automatic remote control over the volume and ringer, a message may be transmitted to the user, providing the user with volume control instructions. Optionally, the user may choose to turn off the mobile device auditory and signaling system for a pre-set period of time. The user may further establish a personal database, which includes a list of preferred callers whose calls will override the control signal adjustment of the mobile device volume, i.e., if the local volume rules require the mobile device to be silent, calls from particular users may still actuate the mobile device's auditory and ringer system.

Further, in certain environments, users of mobile devices may disagree as to preferred volume settings. For example, in a sports stadium, where the ambient noise level is greatly increased, some users may wish to have the volume and ringer sound level of their devices raised, while other users may consider raised volumes and ringer signals of other person's devices to be intrusive. The method of the present invention may optionally provide for the user to select a set of rules to be automatically applied in such situations.

These and other features of the present invention will become readily apparent upon further review of the following specification and drawings.

### BRIEF DESCRIPTION OF THE DRAWINGS

FIG. 1 is block diagram illustrating a method of non-intrusive control of a mobile device according to the present invention.

FIG. 2 is a flowchart showing the steps in a method of non-intrusive control of a mobile device according to the present invention.

FIG. 3 is a block diagram illustrating location determination for a method of non-intrusive control of a mobile device according to the present invention.

Similar reference characters denote corresponding features consistently throughout the attached drawings.

### DETAILED DESCRIPTION OF THE PREFERRED EMBODIMENTS

The present invention is directed towards a method for non-intrusive control of a mobile device that provides for remote regulation of the volume and ringer sound level of a mobile device (as noted above, for purposes of the present application, the term “mobile device” refers to a mobile phone, a handheld terminal, or a portable device). For example, the method allows for the remote control of the volume of a cellular telephone's ring tone and/or of the speaker volume. As will be described in detail below, the method includes the step of determining the geographic location of the user and the mobile device, and dependent upon a set of rules or guidelines associated with the location, a signal is delivered to the mobile device to control the ringer sound level and/or the audio volume. For example, a theater, hospital or school may wish to have ring tones associated with cellular telephones and pagers either lowered or turned off completely. The method provides for the automatic lowering or turning off of the mobile device ringer. Alternatively, a loud environment, such as an athletic stadium, may provide a control signal which automatically raises the ring tone volume, so that the user can hear the ring tone over the noise generated by the crowd, and may also raise the audio speaker volume so that audio messages and voice conversations may be heard.

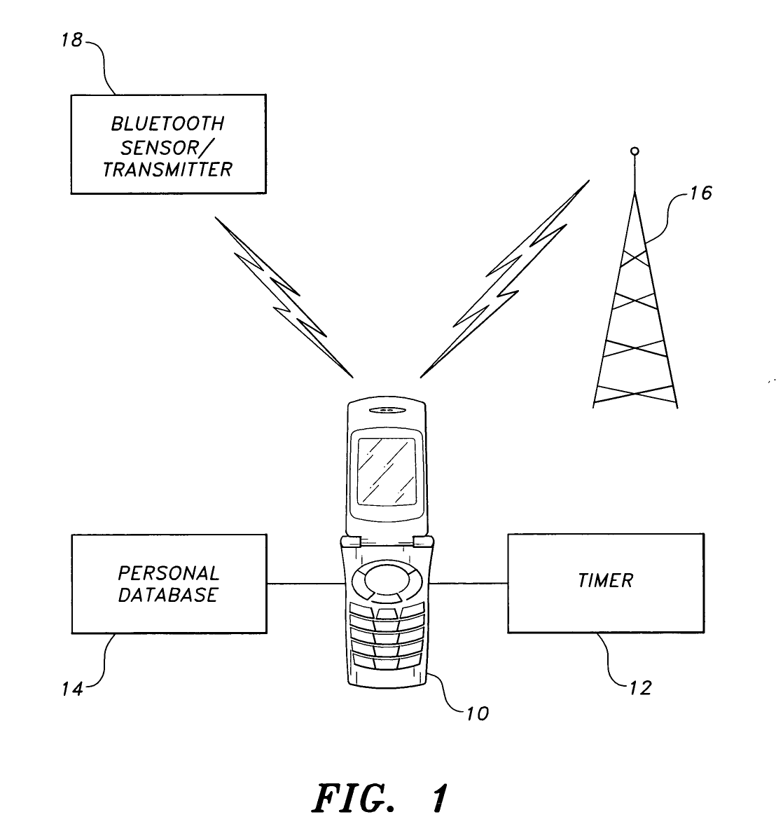

In FIG. 1, a mobile device 10 is provided, which may be a cellular telephone, as shown, a pager, a personal digital assistant or the like. Mobile device 10 may be a mobile telephone, a handheld terminal, or a portable device that requires the setting of audio volume or ringer sound controls. Mobile devices typically fall within one of three separate classes: Class 1 devices are mobile devices with local wireless access for accessing personal area networks (PANs). For example, cellular telephones that are enabled with the IEEE 802.15.1 (better known as “Bluetooth”) wireless protocol for accessing PANs and local wireless devices are Class 1 devices.

Class 2 devices are mobile devices that do not provide access to PANs, but are provided with access to the global positioning system (GPS). Class 3 devices are mobile devices that neither provide access to PANs nor to the GPS. For Class 1 devices, the access point or points responsible for local service coverage (PAN coverage, rather than the voice/data communication) routinely execute service discovery protocol for local wireless service enabled devices. For example, a Bluetooth sensor and transmitter, such as shown in FIG. 1 and designated generally as 18, may be mounted in a local environment and constantly polls the environment to discover, and provide access for, Bluetooth enabled mobile devices. Upon identification of a Class 1 mobile device, such as cellular telephone or PDA 10, the access point 18 will attempt to apply the control policy specific to the location and to the mobile device itself.

For Class 2 and Class 3 mobile devices, the locations of interest are not identified through local wireless service discovery, but through the mobile network infrastructure. A typical wireless network transmitter and receiver base station is represented generally in FIG. 1 as 16. The mobile network infrastructure has the responsibility of attempting the application of the control policy for the mobile device 10. For mobile devices in Classes 2 and 3, this operation requires alteration to the call control and call setup protocols typically used for wireless mobile networks, such as, for example, the ones specified for the global system for mobile communications (GSM), time division multiple access (TDMA), or interim standard 95 (IS-95) compliant mobile devices and their derivatives.

Class 2 mobile devices can send periodic messages to the corresponding wireless network base station identifying the exact coordinates of the mobile device as derived from the GPS receiver module. Alternatively, the mobile network may inquire about the mobile device location upon either the routing of an incoming call (or other communication data transmission) to the mobile device, or the mobile device's request to initiate a call. At this point, the mobile network identifies the location of the mobile device and attempts to apply the control policy. The former alternative requires the mobile device to send its location coordinates information either carried with signaling/voice information or through dedicated signaling messages. The latter alternative requires modification to the call setup procedures followed to route a call to the mobile device or initiate a mobile device call.

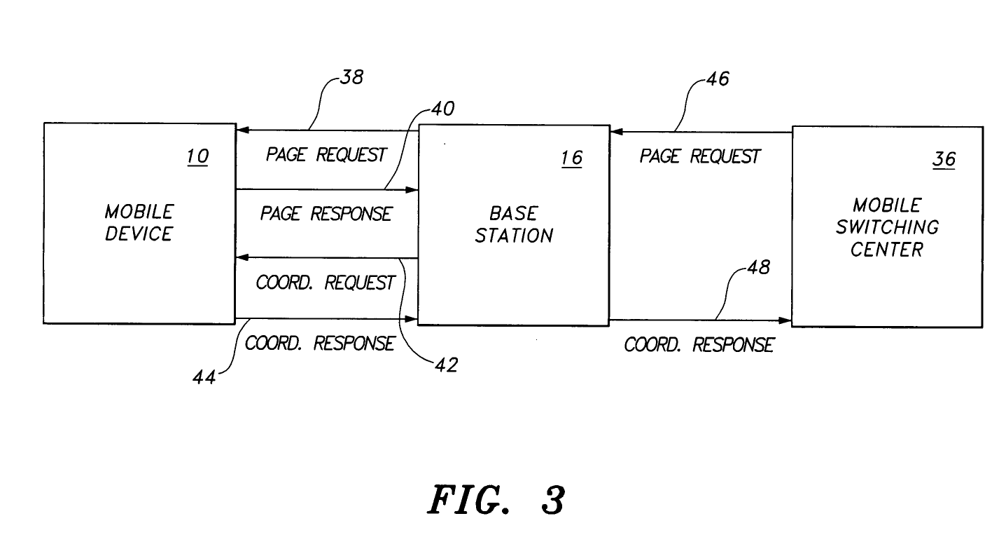

Thus, the location coordinates information may be carried in one of the existing optional fields of the original messages used, or by adding one extra message transaction between the base station and the mobile device. As illustrated in FIG. 3, base station 16 transmits a page request 38 to mobile device 10. Mobile device 10 answers with a page response 40. Upon receipt of the page response 40, base station 16 transmits a request 42 for location coordinates, and mobile device 10 responds with a response transmission 44, including the location coordinates. Multiple base stations 16 are linked by a central mobile switching center 36, which may initiate the location polling process by transmitting a page request 46 to the base station 16. Once the base station 16 has received coordinate response 44 from mobile device 10, the location coordinates are transmitted to switching center 36 in a coordinate response transmission 48.

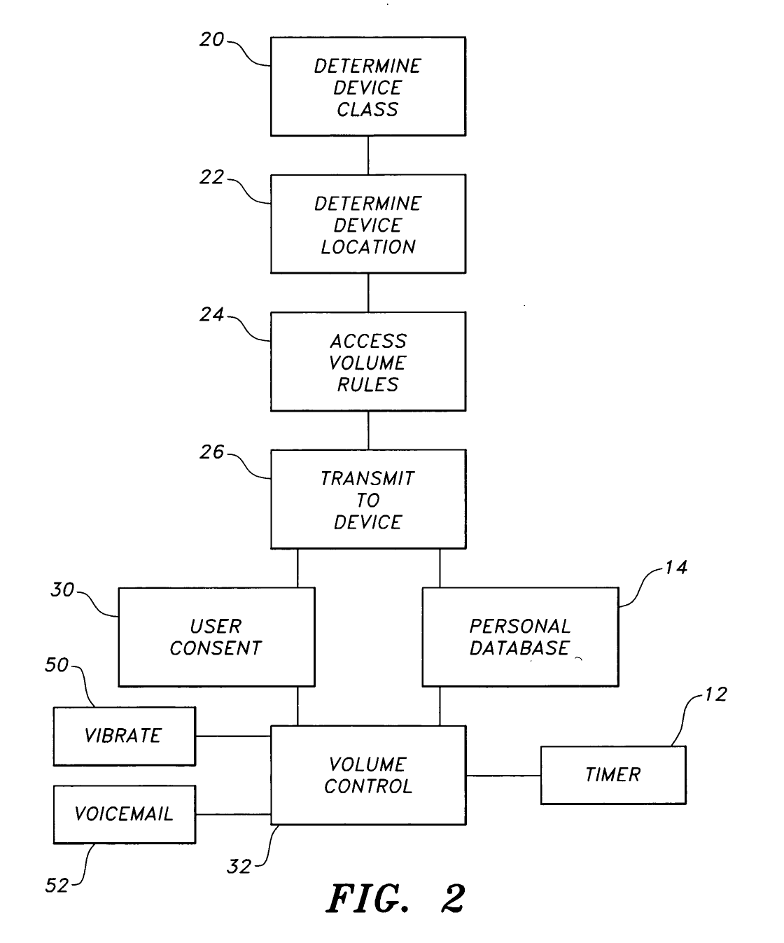

For Class 3 devices, the network determines the location of mobile device 10 through conventional radio direction finding methods, such as, but not limited to, referencing the base station identification information, measuring the received signal level, measuring the time difference between signal transmission and signal reception, measuring the angle of signal arrival, or a combination of the above. Similar to that described above with regard to Class 2 devices, the mobile network inquires about the mobile device location upon either the routing of an incoming call to the mobile device, or the mobile device's request to initiate a call. At this point, the mobile network identifies the location of the mobile device and attempts to apply the control policy. Similarly, a modification to the call setup procedures is required. The determination of the class associated with mobile device 10 is represented generally as 20 in the method flow diagram of FIG. 2.

The identification of locations assumes the network possesses a detailed database/map of locations in the service area, where centers of interest are associated with control policies. Such map-based databases can exist as part of the home location register (HLR) and visiting location register (VLR) databases already commonly associated with wireless networks, and which are typically tagged with the task of tracking the location and properties of the mobile device of interest. The HLR and VLR databases contain the mobile device profiles. The determination of the mobile device location is represented as 22 in FIG. 2.

Local environments may be classified in two ways: First, locations where it is mandatory to control the mobile device ringer volume and, possibly, to turn the ringer off. Such locations may include, for example, airplanes, places of worship, hospitals, courts of law, and the like. Such locations will be referred to hereinafter as mandatory-control locations. Secondly, a local environment may be classified as a consent-basis control location, which are locations requiring user consent in order to remotely control the ringer volume.

A set of control rules is stored in a database, and the location of the mobile device is utilized to access a location-specific subset of the control rules stored within the database. Access to the rules stored in the database is represented as 24 in FIG. 2. A control signal is generated dependent upon this subset and transmitted to the mobile device 10 (26 in FIG. 2), where the ringer sound level, and the audio volume if desired, is raised, lowered or turned off, as indicated at step 32 in FIG. 2, dependent upon the particular control rules. In accordance with the present invention, the mobile device 10 is equipped with appropriate electronic circuitry for receiving a wireless control signal and reducing the ringer sound level and/or the audio volume by software in response to the wireless control signal. Programming an EEPROM or non-volatile memory for a microprocessor-controlled device to act in this fashion would be trivial for one skilled in the electronics art.

For the mandatory-control locations, the control policy will attempt to bring the volume and ringer settings to a zero level. The mobile device may switch to an alternative alert method, such as the production of a vibration (50 in FIG. 2) or a visual signal. As a second operation mode for mandatory-control places, it may be required to send the user of the mobile device a notification message that he or she must turn off the mobile device 10. Further, the network may direct newly incoming calls for such a mobile device to a voicemail system (if this service is prescribed in the mobile profile). Routing of messages to voicemail is represented as 52 in FIG. 2. It should be understood that messages in formats other than voice messages may be similarly routed to any suitable storage medium. Further, the mobile device may be disabled from generating transmissions, other than emergency-related calls.

For consent-basis control locations, the network will identify the mobile device and request the user to approve the control policy for the particular location, as indicated at step 30 in FIG. 2. If the user approves, then the control policy is applied to the mobile device. Furthermore, the user of the mobile device can define a “preferred list” within a personal database (14 in FIGS. 1 and 2), which consists of a list of numbers that the user of the mobile device still wants to receive calls from, or locations of interest with their associated control settings.

If a call from a number (or other caller identifier) on the preferred list is received, then the volume and the ringer settings are kept at their original set values. However, if the originator is not on the preferred list, the control policy is applied where the volume and ringer settings are set at a particular level. The network may further direct incoming calls from certain numbers in the preferred list to the user's voicemail if the user's mobile device's profile allows for such service.

If the mobile device enters a location of interest as set by the preferred list, then the control policy for that area is automatically applied without the consent of the user of the mobile device. In the event that the mobile device did not return an answer to the consent request or the answer was lost, then the network can repeat the request for a predetermined number of times before it decides to leave the mobile device with its initial setting. The user may set location-dependent sets of rules to be stored within the personal preferences database 14. For example, if the user wishes to raise the sound level of the ring tone when in a stadium or other location with an increased ambient noise level, the user may enter the location of the stadium into the database and set the desired ringer sound level parameters (and audio volume parameters, if desired) associated with the location. Then, when the user enters the stadium, the ringer sound levels and audio volume of the telephone is automatically increased.

Alternatively, a timer (generally shown as 12 in FIGS. 1 and 2) may further be provided, allowing the user to silence his or her mobile device for a predetermined period of time. This function is similar in usage to the “snooze” or “mute” function commonly associated with alarm clocks and like. The user may input a pre-set period of time to turn off the device ringer.

It is to be understood that the present invention is not limited to the embodiments described above, but encompasses any and all embodiments within the scope of the following claims.

We claim:

1. A method of non-intrusive control of a mobile device, comprising the steps of:
determining a class of the mobile device;
determining the location of the mobile device, the determination of location being dependent upon the class of the mobile device;
establishing a set of location-dependent rules governing at least ringer sound level of the mobile device;
providing a database containing a set of locations and the set of location-dependent rules;
accessing the database and determining a rules subset of the set of location-dependent rules dependent upon the location of the mobile device;
transmitting a control signal to the mobile device dependent upon the rules subset; and
automatically adjusting the ringer sound level of the mobile device in response to the control signal.

2. The method of non-intrusive control according to claim 1, wherein:
said step of establishing location-dependent rules further comprises establishing a set of location-dependent rules governing both the ringer sound level and audio volume of the mobile device; and
said adjusting step further comprises adjusting both the ringer sound level and the audio volume of the mobile device in response to the control signal.

3. The method of non-intrusive control as recited in claim 1, wherein the mobile device is enabled for a wireless personal area network, said step of determining the location of the mobile device further including the steps of:
providing a local wireless access point within a defined environment, the local wireless access point utilizing a wireless protocol; and
polling the defined environment for mobile devices enabled for communication using the wireless protocol.

4. The method of non-intrusive control as recited in claim 1, wherein the mobile device is GPS-enabled, said step of determining the location of the mobile device further including the step of transmitting GPS location signals between the mobile device and a wireless base station.

5. The method of non-intrusive control as recited in claim 4, wherein the GPS location signals are transmitted between the mobile device and the wireless base station on a periodic basis.

6. The method of non-intrusive control as recited in claim 4, wherein the GPS location signals are transmitted between the mobile device and the wireless base station when communication data is sent or received by the mobile device.

7. The method of non-intrusive control as recited in claim 1, wherein said step of adjusting the ringer sound level comprises lowering the ringer sound level from an initial sound level.

8. The method of non-intrusive control as recited in claim 1, wherein said step of adjusting the ringer sound level includes terminating ringer signals generated at the mobile device.

9. The method of non-intrusive control as recited in claim 1, wherein said step of adjusting the ringer sound level includes raising the ringer sound level from an initial sound level.

10. The method of non-intrusive control as recited in claim 1, further comprising the step of routing incoming messages to the mobile device to a storage medium when the ringer sound level is adjusted to an inaudible sound level.

11. The method of non-intrusive control as recited in claim 1, wherein the mobile device is equipped with a tactile ringer alarm signal capability, the method further comprising the step of switching from an audible ringer signal to the tactile ringer signal when said adjusting step adjusts the ringer sound level to an inaudible sound level.

12. The method of non-intrusive control as recited in claim 1, wherein the step of adjusting the ringer sound level further comprises the step of transmitting a message to the user, the message including sound level control instructions.

13. The method of non-intrusive control as recited in claim 1, further comprising the step of disabling the mobile device from generating transmission signals when the ringer sound level is adjusted to an inaudible level.

14. A method of non-intrusive control of a mobile device, comprising the steps of:
determining the location of the mobile device;
establishing a set of location-dependent rules governing ringer sound level of the mobile device;
providing a database containing a set of locations and the set of location-dependent rules;
accessing the database and determining a rules subset of the set of location-dependent rules dependent upon the location of the mobile device;
transmitting a control signal to the mobile device dependent upon the rules subset; and
requesting user consent to apply the control signal; and
automatically adjusting the ringer sound level of the mobile device responsive to the control signal when the user consents to applying the control signal, and ignoring the control signal when the user refuses consent to applying the control signal.

15. The method of non-intrusive control as recited in claim 14, wherein:
said step of establishing location-dependent rules further comprises establishing a set of location-dependent rules governing both the ringer sound level and audio volume of the mobile device; and
said adjusting step further comprises automatically adjusting both the ringer sound level and the audio volume of the mobile device responsive to the control signal when the user consents to applying the control signal, and ignoring the control signal when the user refuses consent to applying the control signal.

16. The method of non-intrusive control as recited in claim 14, further comprising the step of establishing a personal database containing user-defined rules governing the ringer sound level.

17. The method of non-intrusive control as recited in claim 16, further comprising the step of inputting a set of preferred caller identifiers into the personal database, the control signal being refused if the mobile device receives a transmission from a caller associated with one of the preferred caller identifiers.

18. The method of non-intrusive control as recited in claim 14, further comprising the step of terminating ringer signals generated at the mobile device for a user-defined and programmable period of time.
